(19) United States
(12) Patent Application Publication
(10) Pub. No.: US 2005/0030922 A1
(43) Pub. Date: Feb. 10, 2005

(54) Method for selecting access point based on state information about access point

(76) Inventors: Hyun-Woo Lee, Daejon (KR); Se-Han Kim, Daejon (KR); Won Ryu, Daejon (KR); Chong-Ho Yoon, Seoul (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/830,335

(22) Filed: Apr. 21, 2004

(30) Foreign Application Priority Data
Aug. 7, 2003 (KR) 2003-54588

(51) Int. Cl. H04Q 7/00

(52) U.S. Cl. 370/331; 370/338; 455/436

(57) ABSTRACT

A method for selecting an access point by considering state information including the number of mobile stations connected in each access point and a traffic amount at each access point is disclosed. The method includes the steps of a) at access points, inserting a first state information of the access point about the number of connected mobile stations into a Beacon frame/Probe Response message frame; b) at the access points, the Beacon frame/Probe Response message frame of the first state information is transmitted to the mobile station; c) at the access points, inserting a second state information about a traffic amount into the Beacon frame/Probe Response message frame; d) at each the access points, the Beacon frame/Probe Response message frame of the second state information is transmitted to the mobile station; and e) at the mobile station, selecting one of access points based on the first and second state information.

### FIELD OF THE INVENTION

The present invention relates to a method for establishing a communication link between a mobile station and a wireless local area network LAN; and, more particularly, to a method for effectively selecting an access point AP by considering state information of access points in order to obtain maximum performance of data transmission in a mobile station for using high-speed wireless internet services.

### DESCRIPTION OF RELATED ARTS

Recently, a mobile service provider provides a high speed wireless internet service at a HOT-SPOT area by using a conventional wireless local area network LAN technology, which is introduced for wireless data communication within an indoor place. Registered users can receive the high speed Internet service after authorizing user's registered identification ID. For receiving the high speed Internet service, it requires an association step for selecting one of available access points and establishing a communication link between a mobile station and the selected access point based on IEEE 802.11. Conventionally, an access point having strongest receiving sensitivity is selected and the mobile station receives the high speed Internet service from the selected access point.

However, a performance of data transmission of mobile station may be incredibly decreased according to the number of users receiving the high speed Internet service in identical HOT SPOT area and an amount of traffic processed at the access point. Therefore, if the access point is selected by only considering the receiving sensitivity of the access point, the maximum performance of the mobile station can not be guaranteed. Also, it is not effective method for selecting the access point in a view of the service provider for managing entire network.

In other words, the mobile station of the user can not be guaranteed to have maximum data transmission speed defined in a wireless LAN standard of IEEE 802.11 in a HOT SPOT area where in a carrier sense multiple access/collision avoidance is used as a media accessing method and a number of users are frequently moving such as a bus terminal, a exhibition place and conference hall. In the above mentioned case, the performance of the mobile station is suddenly decreased according to the number of users connected to the selected access point and the amount of traffic processed at the selected access point.

### SUMMARY OF THE INVENTION

It is, therefore, an object of the present invention to provide a method for effectively selecting an access point by considering state information including the number of mobile stations connected in each access point and a traffic amount at each access point.

It is another object of the present invention to provide a method for effectively selecting an access point by using a Beacon frame or a Probe response message frame in media access control layer of wireless LAN accessing device based on IEEE 802.11.

It is still another object of the present invention to provide a method for effectively selecting an access point based on state information of access point in a Beacon frame or a Probe response message frame.

In accordance with an aspect of the present invention, there is provided a method for selecting access point among a plurality of access points in a wireless local area network environment to establish a physical channel between a mobile station and a wireless local area network, the method including the steps of: a) at each of plurality of access points, inserting a first state information of the access point about the number of connected mobile stations into a Beacon frame/Probe Response message frame of wireless local area network LAN media access control MAC layer; b) at each of plurality of the access points, the Beacon frame/Probe Response message frame of the first state information is transmitted to the mobile station; c) at each of plurality of the access points, inserting a second state information about a currently processed traffic amount into the Beacon frame/Probe Response message frame; d) at each of plurality of the access points, the Beacon frame/Probe Response message frame of the second state information is transmitted to the mobile station; and e) at the mobile station, selecting one of access points based on the first and second state information.

In accordance with an aspect of the present invention, there is also provided a computer readable recoding medium storing a set of instructions for executing a method of selecting access point among a plurality of access points in a wireless local area network environment to establish a physical channel between a mobile station and a wireless local area network, the method including the steps of: a) at each of plurality of access points, inserting a first state information of the access point about the number of connected mobile stations into a Beacon frame/Probe Response message frame of wireless local area network LAN media access control MAC layer; b) at each of plurality of the access points, the Beacon frame/Probe Response message frame of the first state information is transmitted to the mobile station; c) at each of plurality of the access points, inserting a second state information about a currently processed traffic amount into the Beacon frame/Probe Response message frame; d) at each of plurality of the access points, the Beacon frame/Probe Response message frame of the second state information is transmitted to the mobile station; and e) at the mobile station, selecting one of access points based on the first and second state information.

### BRIEF DESCRIPTION OF THE DRAWINGS

The above and other objects and features of the present invention will become better understood with regard to the following description of the preferred embodiments given in conjunction with the accompanying drawings, in which:

FIG. 1 is a diagram showing a public wireless local area network LAN service system in accordance with a preferred embodiment of the present invention;

FIG. 2 is a diagram of wireless local area network environment in which the present invention is implemented;

FIG. 3 is a flowchart illustrating a method for effectively selecting an access point based on state information of access points in accordance with a preferred embodiment of the present invention;

FIGS. 4A and 4B are diagrams showing a method for selecting access point of a passive searching type in accordance with the present invention;

FIG. 5 is a diagram for illustrating a method for effectively selecting access point of an active searching type in accordance with a preferred embodiment of the present invention;

FIG. 6 is a diagram showing a structure of Beacon frame in accordance with a preferred embodiment of the present invention;

FIG. 7 is a diagram illustrating a structure of a Probe Response message frame in accordance with a preferred embodiment of the present invention; and

FIG. 8 is diagram showing examples of amount bits and indication bit set in AP capability region in accordance with a preferred embodiment of the present invention.

### DETAILED DESCRIPTION OF THE INVENTION

Hereinafter, a method for selecting an access point AP based on state information of access points according to the present invention will be described in more detail with reference to the accompanying drawings.

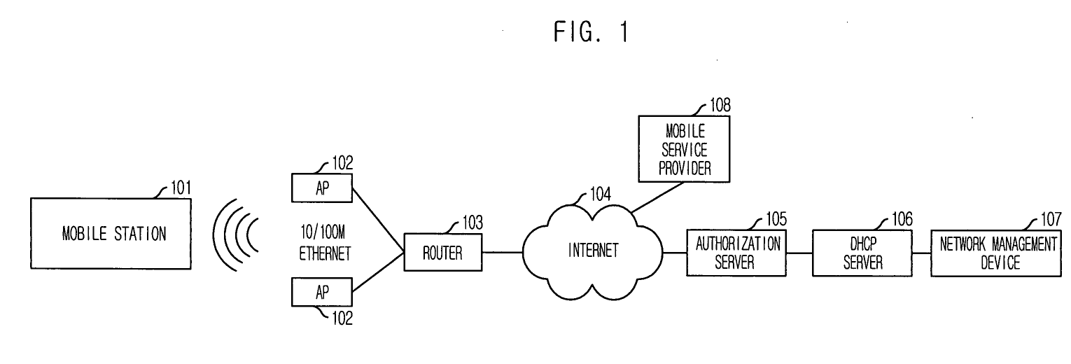

FIG. 1 is a diagram showing a public wireless local area network LAN service system in accordance with a preferred embodiment of the present invention. Referring to FIG. 1, the public wireless LAN service system includes a mobile station 101, a plurality of access points AP 102, a router 103, an Internet 104, an authorization service 105, a dynamic host configuration protocol DHCP server 106, a network management device 107 and a mobile service provider 108.

For receiving the high speed wireless Internet service based on the wireless LAN technology, a user installs a wireless LAN card into the mobile station 101 and receives a permission to receive the high speed wireless Internet service from the authorization server 105 managed by the mobile service provider 108 through one of the access points 102 which are connected to the Internet 104. After receiving the permission, the user can access to a server of the service provider 108. For providing the high speed wireless Internet service, a public wireless LAN service network is constructed with a plurality of access points AP 102 within a service area in which a number of users is gathered and connecting the access points 102 to the router 103 based on a dedicated line. Furthermore, the service provider 108 implements the DHCP server 106 for allocating internet protocol IP address to the mobile station 101 and the network management device 107.

In a conventional wireless LAN environment based on IEEE 802.11, one of access points having strongest receiving sensitivity is selected and the mobile station 101 of the user receives data by establishing a physical channel between the mobile station 101 and the selected access point 102.

However, the present invention selects one of the access points 102 by considering not only the receiving sensitivity but also the number of the mobile station connected to each access point and an amount of traffic processed at each access point for establishing the physical channel between the mobile station 101 and access point 102.

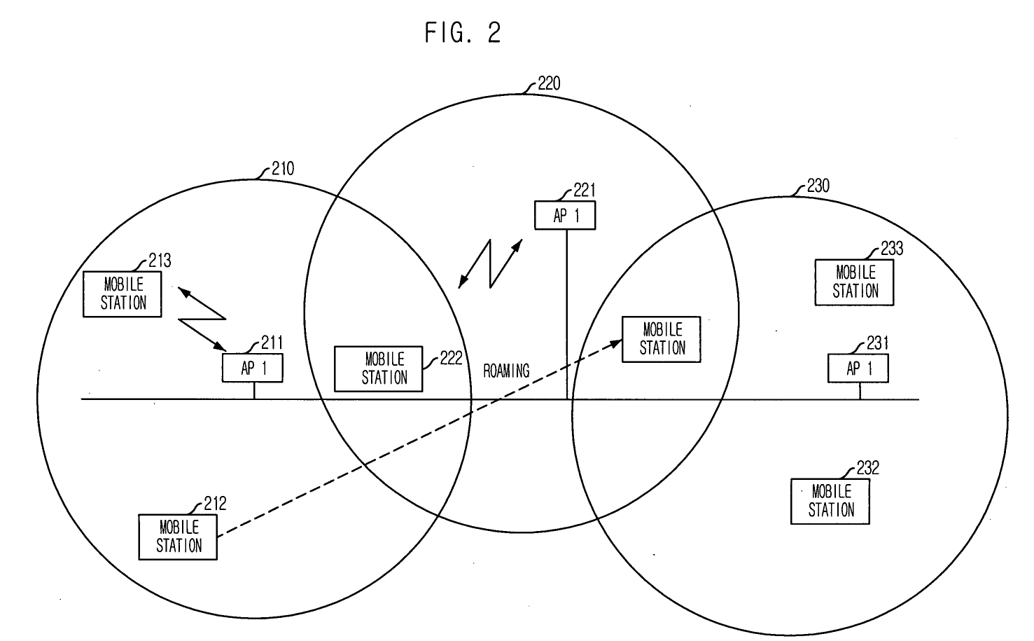

FIG. 2 is a diagram of wireless local area network environment in which the present invention is implemented. It shows that connections between the mobile station and access point in a HOT SPOT area in the wireless local area network environment. At first, conventional steps for initial association of the mobile station and access point, roaming, and re-association are explained in detail hereinafter.

Referring to FIG. 2, there are three access points 211, 221 and 231 which having overlapped service areas 210, 220 and 230. The access point 211 is connected to mobile stations 212 and 213 at the access point 211's service area 210. A mobile station 221 is connected to the access point 221 at the service area 220. Furthermore, the access point 231 is connected to mobile stations 232 and 233 at the service area 230.

At first, the mobile station needs to establish a physical channel to the access point based on IEEE 802.11 through an authorization step of the service provider. That is, the mobile station 212 passively or actively searches the access point when the mobile station 212 is powered on or the mobile station 212 enters a service area 210 of the access point 211. The mobile station 212 selects an access point by considering the receiving sensitivity of the access point and establishes the physical channel to the selected access point having strongest receiving sensitivity. In case of Roaming operation which the mobile station connected to the selected access point enters a service area of another access point, the mobile station establishes new physical channel to another access point by detecting decrease of receiving sensitivity of the previously selected access point through an AP re-association step.

That is, when the Roaming operation is invoked by the mobiles station 212 entering to the services area 220 or 230 of the access points 221 or 231, the mobile station detects decrease of receiving sensitivity of the access point 211 and establishes new physical channel to another access point by selecting another access point between the access points 221 and 231 through AP re-association step.

However, in the present invention, the access point is effectively selected by comparing state information of access points received from the access points in order to have the maximum performance of data transmission during initial association step and re-association step. The state information is includes not only the receiving sensitivity of the access points but also the number of mobile stations connected to the access point and the traffic amount of the access point.

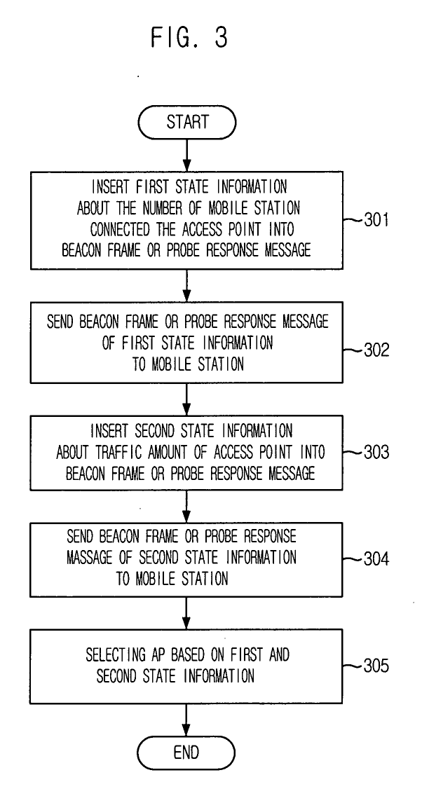

FIG. 3 is a flowchart illustrating a method for effectively selecting an access point based on state information of access points in accordance with a preferred embodiment of the present invention.

Referring to FIG. 3, at an access point, a first state information about the number of mobile stations connected to each access point is inserted in a Beacon frame or Probe Response message frame of wireless LAN MAC layer at step 301. The beacon frame or the Probe Response message frame of the first state information is send to the mobile station at step 302. A second state information about an amount of traffic processed in the access point is inserted to the Beacon frame or the Probe Response message frame at step 303. The Beacon frame or the Probe Response message frame of the second state information is transmitted to the mobile station at step 304.

The mobile station compares the first and second state information of access points and selects one of access points which provides comparatively high data transmission performance to the mobile station at step 305. Reference for selecting access point may be alternative. However, lowest traffic amount currently processed and less number of mobile stations connected are preferable to set as a reference to select appropriate access point.

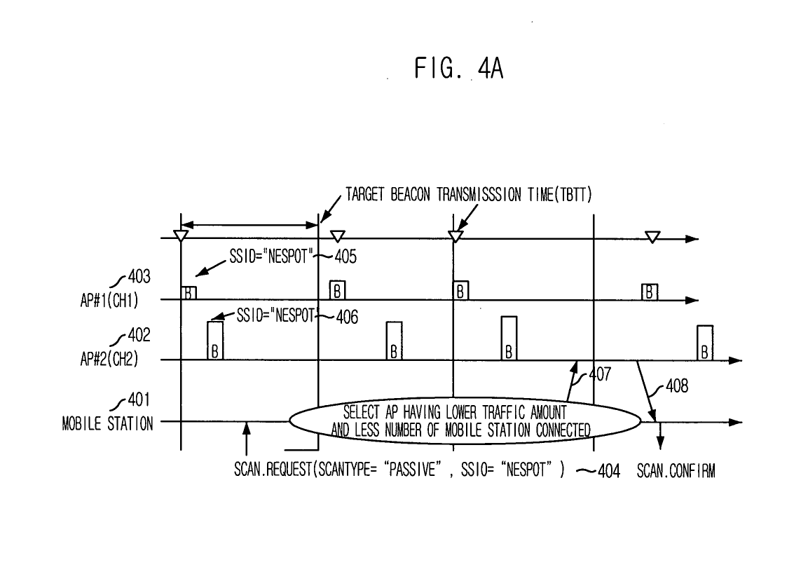

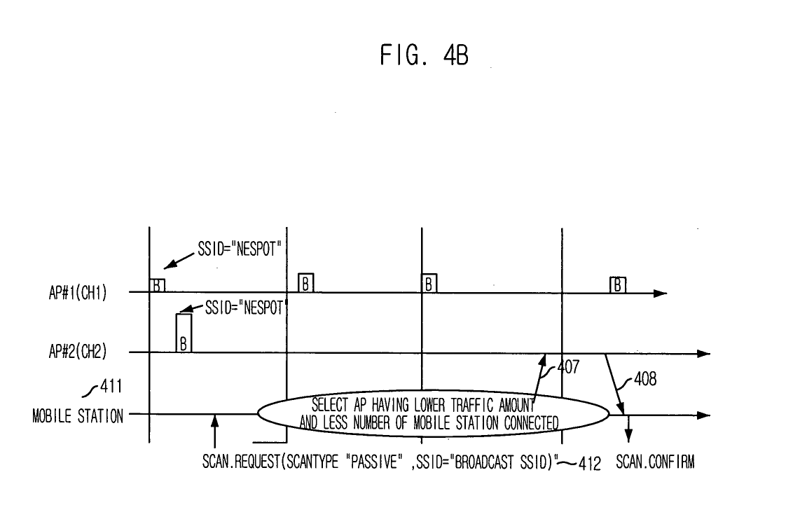

FIGS. 4A and 4B are diagrams showing a method for selecting access point in accordance with a preferred embodiment of the present invention. Referring to FIGS. 4A and 4B, passive type AP searching step and association step in a wireless LAN environment based on IEEE 802.11 are explained.

FIG. 4A shows passive type AP searching step and association step in a case that a user of mobile station sets a subsystem identification SSID to a predetermined value “nespot” to receive wireless data service from predetermined wireless data service provider.

Referring to FIG. 4A, a mobile station 401 compares a Beacon frame 405 of the access point 403 and a Beacon frame 406 of the access point 402 which have a value of “nespot” as the SSID by searching SSIDs of each channel at physical layer. The mobile station 401 selects one of access points 402 and 403 having lower traffic amount and less number of mobile stations connected and transmits a request message for establishing a physical channel at step 407. When the selected access point receives the request message at step 408, the physical channel is established between the mobile station and the selected access point.

FIG. 4B shows passive type AP searching step and association step in a case that a user of mobile station set subsystem identification SSID to “broadcast SSID”. That is, the user does not have preferable wireless data service provider to receive wireless data service.

Referring to FIG. 4B, if the mobile station 401 searches an access point by setting the SSID value as “broadcast SSID” in the AP searching step, the mobile station 401 receives Beacon frames of all channels without considering SSID of access point and selects appropriate access point among the available access points.

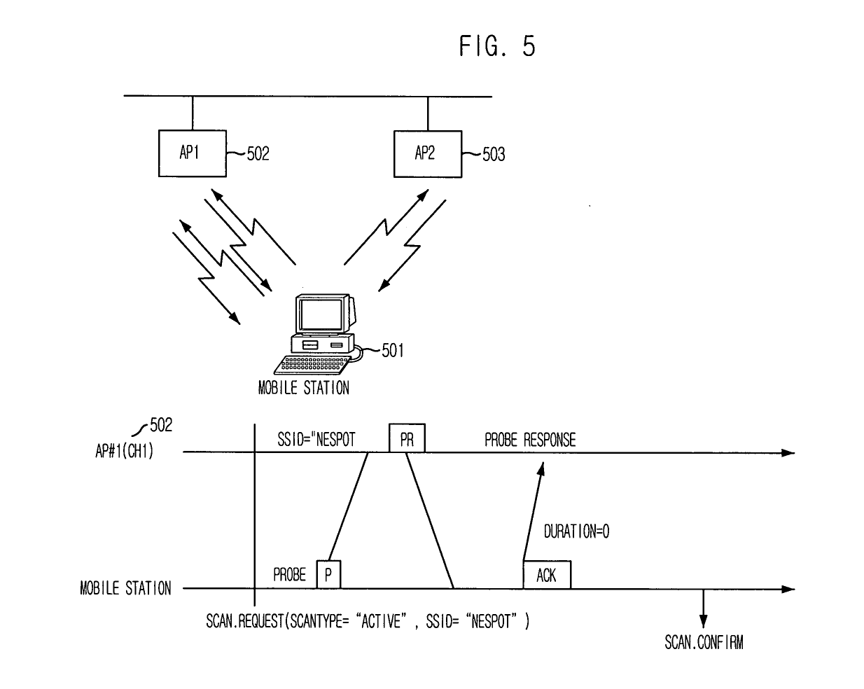

FIG. 5 is a diagram for illustrating a method for effectively selecting access point in accordance with another preferred embodiment of the present invention. Referring to FIG. 5, an active type AP searching step and association step in a wireless LAN environment based on IEEE 802.11 are explained. It assumes that a user of the mobile station sets SSID as “nespot”.

At first, the mobile station 501 transmits a Probe message to access points 502 and 503 having identical SSID value as “nespot” by searching each channel at physical layer. The access points 502 and 503 transmit a Probe response message by inserting a first state information about the number of mobile station connected and a second state information about the traffic amount in the Probe response message.

The mobile station 501 compares the first and second state information in the probe response messages of the access points 502 and 503 and selects appropriate access points between the access points 502 and 503. If the access point 502 is selected, the mobile station transmits a request message for establishing the physical channel. If the access pint 502 receives the request message, the physical channel is established.

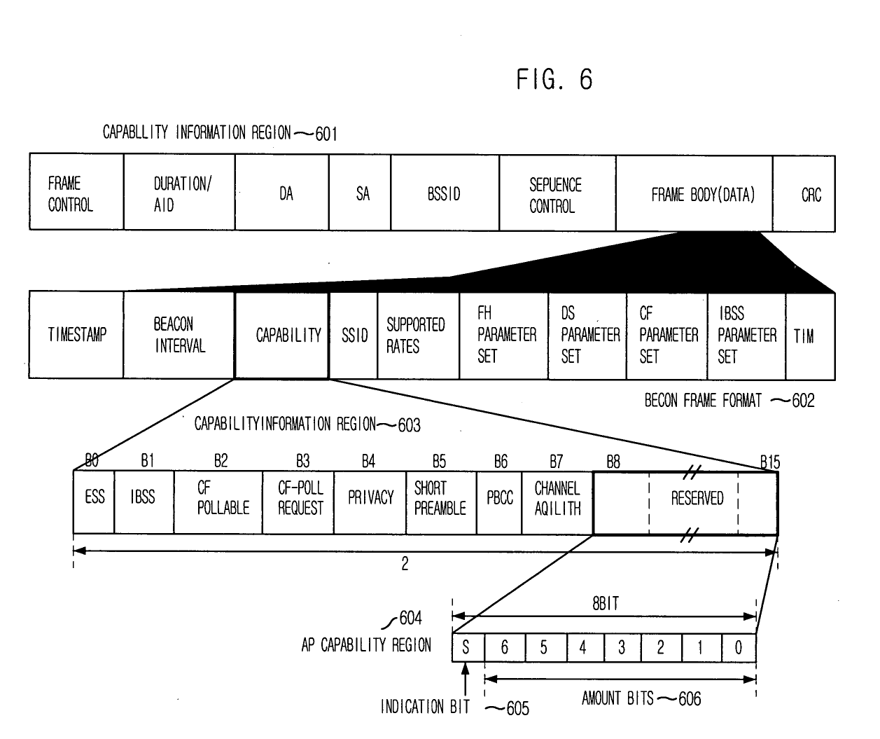

FIG. 6 is a diagram showing a structure of Beacon frame in accordance with a preferred embodiment of the present invention. That is, FIG. 6 shows a region of Beacon frame representing a first state information and a second state information of access point in accordance with a preferred embodiment of the present invention.

In the present invention, the first state information about the number of mobile stations connected to an access point and the second stat information about the traffic amount processed at the access point are inserted into a capability information region of the Beacon frame, which represents media accessing information broadcasted to mobile stations in passive AP searching method at MAC layer based on IEEE 802.11.

Referring to FIG. 6, a format of data regions 602 is a format of a Beacon frame in general management frame format 601 which is defined by IEEE 802.11. There is a 1 byte of reserved region 604 in 2 bytes of capability information region 603.

In the present invention, the reserved region 604 is used as an AP capability region 604 representing the first or second state information of corresponding access point. Among 8 bits of the AP capability region 604, the first bit is used as an indication bit 605 and remained 7 bits are used as amount bits 606. That is, if the indication bit is “0” in binary number, it represents the first state information. That is, the AP capability region 604 contains information about the number of mobile station connected to the access point. The amount bits 606 contains the number of mobile stations connected to the access point in binary number form. If the indication bit is “1” in binary format, the AP capability region 604 contains the second state information about the amount of traffic processed at a port of MAC of access point.

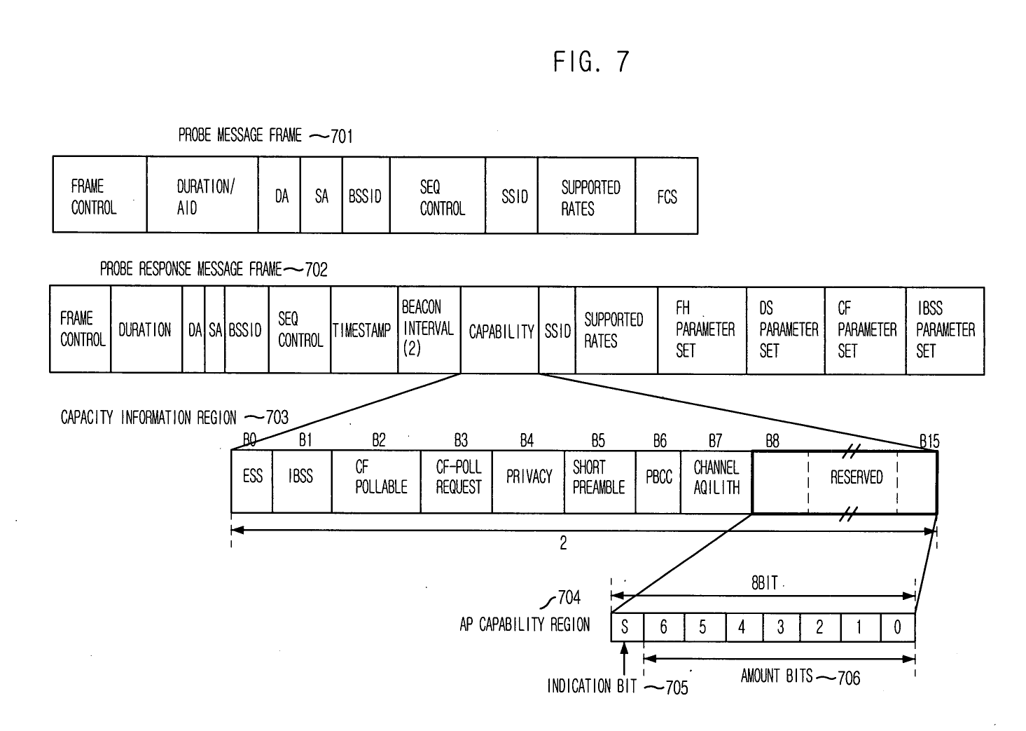

FIG. 7 is a diagram illustrating a structure of a Probe Response message frame in accordance with a preferred embodiment of the present invention. That is, FIG. 7 shows a region of Probe Response message frame representing a first state information and a second state information of access point in accordance with a preferred embodiment of the present invention.

The Probe message frame 701 is transmitted to access points in an active AP searching method in a wireless LAN environment based on IEEE 802.11. The present invention uses a capability information region of the Probe Response message frame to represent the first and second state information of the access point.

FIG. 7 shows formats of Probe message frame 701 and Probe Response message frame 702 defined in IEEE 802.11. In 2 bytes of capability information region 703 of the Probe response message frame 702, there is a reserved region 704. The present invention uses the reserved region 704 as an AP capability region 704 to represent the first and second state information.

Referring to FIG. 7, 8 bits of the AP capability region 704 is divided to one bit of an indication bit 705 representing a type of state information and seven bits of a amount bits 706 representing amount or number corresponding type of state information.

That is, if the indication bit 705 is “0” in binary number, the AP capability region 704 contains the first state information about the number of mobile station connected to an access point. Accordingly, the amount bits 706 contains the number of the mobile stations connected to the access point in binary number. If the indication bit 705 is “1” in binary number, the AP capability region 704 includes the second state information about the traffic amount and the amount bits 706 contains a binary number representing the amount of traffic processed at the access point.

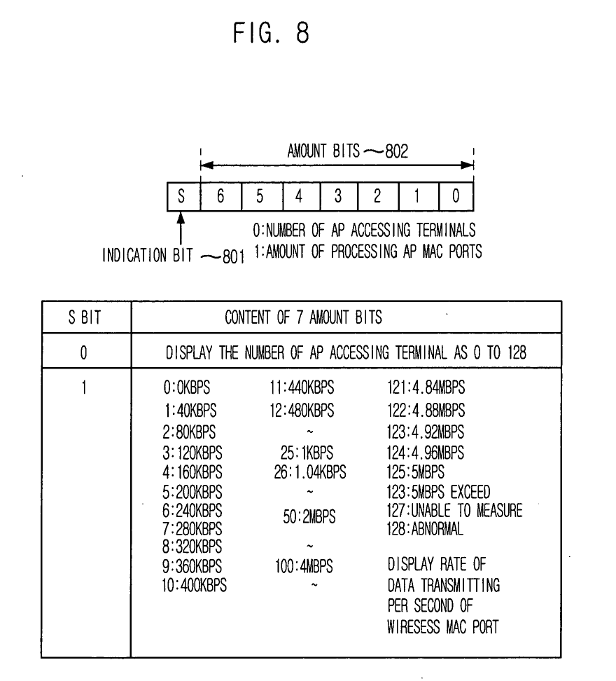

FIG. 8 is diagram showing examples of amount bits and indication bit set in AP capability region in accordance with a preferred embodiment of the present invention.

Referring to FIG. 8, if the indication bit 801 is “0”, the amount bits 802 represents the number of mobile station connected to the access point. Accordingly, seven bits of the amount bits 802 can represent the number of the mobile station to 0 to 128. Also, the indication bit 801 is 1, the amount bits represents the traffic amount processed at the access point. As shown in FIG. 8, the traffic amount is represented as bit per second which is amount of transmitting to media access control MAC port of the wireless LAN and 128 types of traffic amounts can be represented. The transmitting amount is an amount of data transmitted excepting header region of wireless media access control frame.

As mentioned above, in the present invention, an AP searching step between a passive type and active type is distinguished and state information of access point are transmitted to the mobile station by inserting the first and second state information into the Beacon frame or the Probe Response message frame, respectively. The mobile station compares the first and second state information of access points and selects appropriate access point based on the state information of access points including the receiving sensitivity, the number of mobiles station connected to the access point and the traffic amount.

The present invention can be implemented as a software program which can be stored at a computer readable recoding medium such as a CD-ROM, RAM, ROM, floppy disk, hard disk and optical magnetic disk.

As mentioned above, in the present invention, the mobile station can have the maximum performance of transmitting data by effectively selecting access point based on state information of access points about an receiving sensitivity, the number of mobile stations connected to each access point and the traffic amount of each access point included in a Beacon frame and a Probe response message frame.

The present application contains subject matter related to Korean patent application No. KR 2003-0054588, filed in the Korean patent office on Aug. 7, 2003, the entire contents of which being incorporated herein by reference.

While the present invention has been described with respect to certain preferred embodiments, it will be apparent to those skilled in the art that various changes and modifications may be made without departing from the spirit and scope of the invention as defined in the following claims.

1. A method for selecting access point among a plurality of access points in a wireless local area network environment to establish a physical channel between a mobile station and a wireless local area network, the method comprising the steps of:
a) at each of plurality of access points, inserting a first state information of the access point about the number of connected mobile stations into a Beacon frame/Probe Response message frame of wireless local area network LAN media access control MAC layer;
b) at each of plurality of the access points, the Beacon frame/Probe Response message frame of the first state information is transmitted to the mobile station;
c) at each of plurality of the access points, inserting a second state information about a currently processed traffic amount into the Beacon frame/Probe Response message frame;
d) at each of plurality of the access points, the Beacon frame/Probe Response message frame of the second state information is transmitted to the mobile station; and
e) at the mobile station, selecting one of access points based on the first and second state information.

2. The method as recited in claim 1, wherein in the step b), the first state information is inserted into a capability information region of the Beacon frame/Probe Response message frame.

3. The method as recited in claim 1, wherein in the step d), the traffic information is inserted into a capability information region of the Beacon frame/Probe response message frame.

4. The method as recited in claim 3, the capability information region includes:
a indication bit for representing a type of state information included in the capability information region, wherein the type information is one of the first state information and the second state information; and
a amount bits for representing an amount of traffic and the number of the mobile stations according to the indication bit.

5. The method as recited in claim 1, wherein the step e) includes the steps of:
e-1) comparing the first state information and the second state information of a plurality of the access points; and
e-2) selecting an access point having less number of mobile stations connected and small amount of traffic among the access points based on the comparing result of the step d-1).

6. A computer readable recoding medium storing a set of instructions for executing a method of selecting access point among a plurality of access points in a wireless local area network environment to establish a physical channel between a mobile station and a wireless local area network, the method comprising the steps of:
a) at each of plurality of access points, inserting a first state information of the access point about the number of connected mobile stations into a Beacon frame/Probe Response message frame of wireless local area network LAN media access control MAC layer;
b) at each of plurality of the access points, the Beacon frame/Probe Response message frame of the first state information is transmitted to the mobile station;
c) at each of plurality of the access points, inserting a second state information about a currently processed traffic, amount into the Beacon frame/Probe Response message frame;
d) at each of plurality of the access points, the Beacon frame/Probe Response message frame of the second state information is transmitted to the mobile station; and
e) at the mobile station, selecting one of access points based on the first and second state information.
